(19) United States
(12) Patent Application Publication
(10) Pub. No.: US 2006/0290281 A1
(43) Pub. Date: Dec. 28, 2006

(54) Cold cathode fluorescent lamp module

(75) Inventors: Ruey-Feng Jean, Taoyuan Hsien (TW); Kuang-Lung Tsai, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/471,591

(22) Filed: Jun. 21, 2006

(30) Foreign Application Priority Data
Jun. 28, 2005 (TW) 094121531

(51) Int. Cl. H01J 1/62; H01J 61/30

(52) U.S. Cl. 313/631; 313/634; 313/493

(57) ABSTRACT

A cold cathode fluorescent lamp module includes a substrate, an electrode pair, and a cold cathode fluorescent lamp (CCFL). In this case, the electrode pair has a first electrode and a second electrode, which are alternately disposed on the substrate. The CCFL is located on the substrate and connected with the first electrode and the second electrode.

### BACKGROUND OF THE INVENTION

1. Field of Invention

The invention relates to a cold cathode fluorescent lamp module and, in particular, to a cold cathode fluorescent lamp module with an external electrode structure.

2. Related Art

The backlight module is a key element widely used in the fabrication of flat displays, in particular, in the liquid crystal displays. The backlight module is commonly installed at the rear side of the liquid crystal display panel. According to different functional demands, the backlight modules are typically divided into major categories: the direct-type and the edge light type. In practice, the direct-type backlight module has better light-usage efficiency than the side-edge backlight module, so that the direct-type backlight module is more suitable for the display panel with higher luminance or with large size such as the TV panel.

At present, a clod cathode florescent lamp is commonly used as the light source of the backlight module. With reference to FIG. 1, the conventional cold cathode florescent lamp 10 includes a sealed tube 101 filled with a mixture rare gas and the mercury vapor. Besides, a florescent layer 102 is coated on the inner surface of the tube 101. A pair of metal electrodes 103 is embedded into two ends of the tube 101 respectively. A lead 11 coupling to each metal electrode 103 passes through the tube 101 and then connects to a high voltage power supply 12. The high voltage power supply 12 drives the metal electrodes 103 to emit electrons, and then the emitted electrons are accelerated in a high electric field to collide with the rare gas and the mercury vapor in the tube 101. As a result of energy exchange, the ultraviolet rays are generated when the rare gas and the mercury vapor drop from the excited state to the ground state. After that, the ultraviolet rays excite the fluorescent material layer 102 on the inner surface of the tube 101 to emit visible light eventually.

With reference to FIG. 2, a conventional direct-type backlight module 1 is installed at the rear side of a liquid crystal display panel 13. The backlight module 1 is typically fabricated with a plurality of cold cathode fluorescent lamps 10 arranged in parallel in an accommodated space 20 defined by a diffusion plate 14 and a reflective plate 15. The reflective plate 15 is used to reflect light from the cold cathode fluorescent lamps 10 for increasing light-usage efficiency while the diffusion plate 14 is used to diffuse the reflected light as uniform light.

However, due to the metal electrodes 103 in the cold cathode fluorescent lamp 10 of the backlight module 1 is gradually consumed by the bombardments of ions and electrons, the lifetime of the cold cathode fluorescent lamp 10 is interfered. In the present day, the deterioration of the metal electrodes 103 is dramatically noticeable because of demanding for higher luminance of the cold cathode fluorescent lamp 10. Therefore, the different structures of the external electrode for the cold cathode fluorescent lamp 10 are aggressively developing nowadays in order to avoid the consumption of metal electrodes 103 so as to effectively extend lifetime of the cold cathode fluorescent lamp 10.

Therefore, it is an important subject of the invention to provide a cold cathode fluorescent lamp module with external electrode structure.

### SUMMARY OF THE INVENTION

In view of the foregoing, the invention is to provide a cold cathode fluorescent lamp module with external electrode structure that is rapidly assembled, has a simple structure, and is suitable for mass-production.

To achieve the above, a cold cathode fluorescent lamp module of the invention includes a first substrate, a second substrate, an electrode pair, and a cold cathode fluorescent lamp (CCFL). In this aspect, the second substrate is disposed opposite to the first substrate. The electrode pair has a first electrode and a second electrode disposed on the first substrate and the second substrate, respectively. The CCFL locates between the first substrate and the second substrate.

To achieve the above, another cold cathode fluorescent lamp module of the invention includes a substrate, an electrode pair, a cold cathode fluorescent lamp (CCFL). In this aspect, the electrode pair has a first electrode and a second electrode alternately disposed on the substrate. The CCFL disposed on the substrate.

As mentioned above, the invention is to dispose the electrode pair of the cold cathode fluorescent lamp module on a substrate or two substrates. Herein, the electrode pair includes a first electrode and a second electrode. The first electrode and the second electrode can be staggered to each other on the same substrate. In addition, the first electrode and the second electrode also can be respectively disposed on two substrates i.e. the first substrate and the second substrate. In such a manner, the first electrode and the second electrode can be aligned to each other with symmetry or interlaced. Therefore, this invention is to dispose the electrode pair on the substrate so as to form a cold cathode lamp fluorescent module with an external electrode structure. Accordingly, the sealing procedure in the production of the internal metal electrode structure is eliminated and thus the yield, reliability, and lifetime of the product are further improved. Meanwhile, due to the electrode pair is disposed on the substrate, the following assembly of the cold cathode fluorescent lamp to fabricate the cold cathode fluorescent lamp module is simplified. Thus, the requirements of the rapid assembly and mass-production are obtained.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional cold cathode florescent lamp;

FIG. 2 is a schematic view showing the conventional direct-type backlight module;

FIG. 3 to FIG. 7 are a set of schematic views showing a cold cathode fluorescent lamp module according to a preferred embodiment of the invention;

FIG. 8 is a schematic view showing a specific implement of the cold cathode fluorescent lamp module according to the preferred embodiment of the invention;

FIG. 9 and FIG. 10 are a set of schematic views showing a cold cathode fluorescent lamp module according to another preferred embodiment of the invention; and

FIG. 11 is a schematic view showing a specific implement of the cold cathode fluorescent lamp module according to another preferred embodiment of the invention.

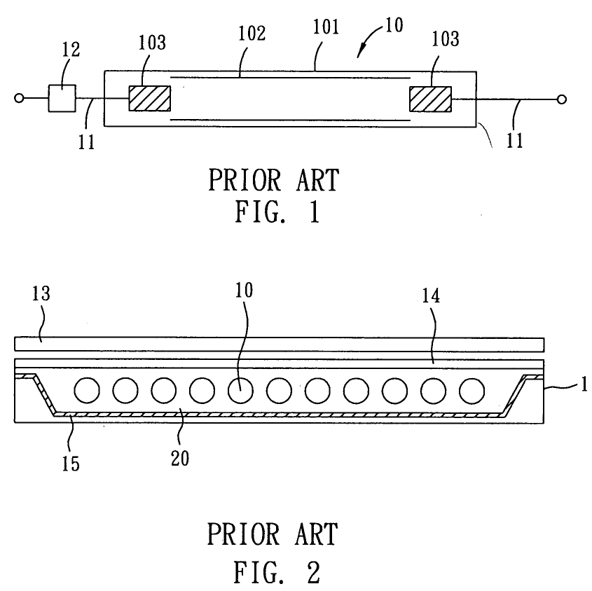

### DETAILED DESCRIPTION OF THE INVENTION

The present invention will be apparent from the following detailed description, which proceeds with reference to the accompanying drawings, wherein the same references relate to the same elements.

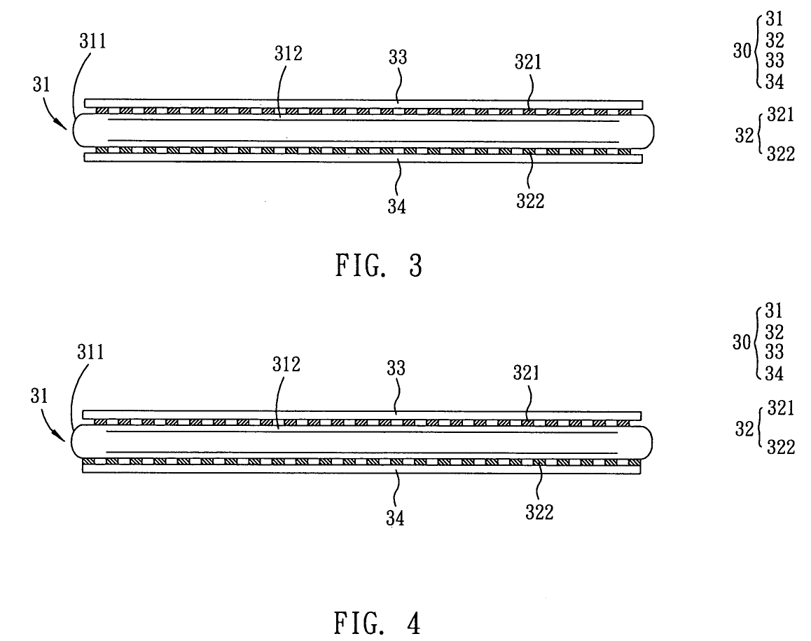

With reference to FIG. 3, a cold cathode fluorescent lamp module 30 according to a preferred embodiment of the invention includes a first plat 33, a second substrate 34, at least one electrode pair 32, and at least one cold cathode fluorescent lamp (CCFL) 31. In this case, the first substrate 33 is located opposite to the second substrate 34.

In the present embodiment, the CCFL 31 is disposed between the first substrate 33 and the second substrate 34 includes a transparent housing 311, a gas medium, and a fluorescent material layer 312. The gas medium is filled in the transparent housing 311 and the fluorescent material layer 312 is coated on inner surface of the transparent housing 311. In this case, the transparent housing 311 can be a sealed tube, and the gas medium includes a rare gas and a mercury vapor.

The electrode pair 32 includes a first electrode 321 and a second electrode 322. With reference to FIG. 3, the first electrode 321 and the second electrode 322 are disposed on the first substrate 33 and the second substrate 34, respectively. In this case, the first substrate 33 can be a diffusion substrate while the second substrate 34 can be a reflective substrate. If necessary, the first substrate 33 and the second substrate 34 also can be both the diffusion substrates.

As mentioned above, the CCFL 31 is disposed between the electrode pair 32. The arrangement of the first electrode 321 and the second electrode 322 can be the aligned configuration with symmetry (as shown in FIG. 3) or aligned interlaced configuration (as shown in FIG. 4). That is, the first electrode 321 and the second electrode 322 are external from the CCFL 31, the CCFL 31 has no longer any electrode disposed therein.

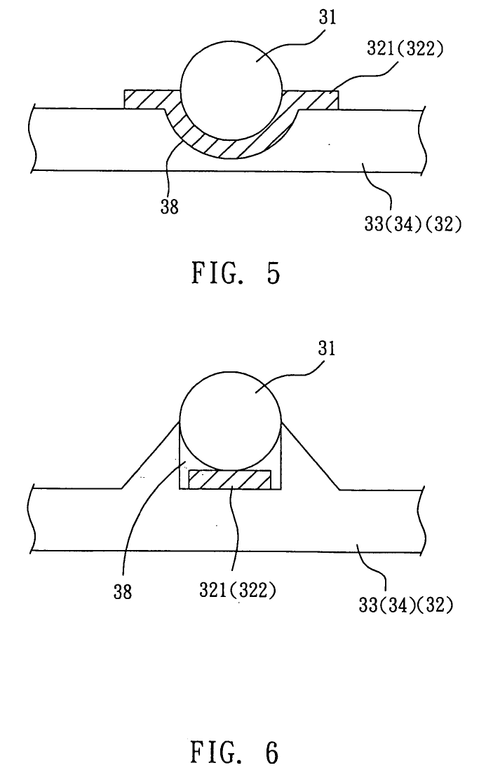

With reference to FIG. 5, the first substrate 33 or the second substrate 34 further includes at least one accommodating area 38 used for providing an easier way on fixing and accommodating the CCFL 31. The electrode pair 32 is disposed in the accommodating area 38 and positioned between the CCFL 31 and the first substrate 33 or the second substrate 34. The accommodating area 38 is concaved from the surface of the first substrate 33 or the second substrate 34. At least one portion of the first electrode 321 or the second electrode 322 is accommodated in the accommodating area 38. More specificity, the first substrate 33 and the second substrate 34 of the cold cathode fluorescent lamp module 30 can respectively have the accommodating areas 38 concaved from the surfaces of the substrates 33 and 34. Alternatively, one of the substrates 33 and 34 has the accommodating area 38 concaved from the surface of the first substrate 33 or the second substrate 34. In such a manner, at least one portion of the CCFL 31 is accommodated in the accommodating area 38 and contacts tightly with the first electrode 321 and the second electrode 322. In this case, the sectional shape of the accommodating area 38 is at least one selected from the group consisting of semicircle-shaped, arc-shaped, V-shaped, and parabolic curve-shaped.

Alternatively, with reference to FIG. 6, the accommodating area 38 also can protrude from the surface of the first substrate 33 or the second substrate 34 and have at least two blockers for fixing the CCFL 31. The first electrode 321 or the second electrode 322 is constructed in the accommodating area 38. The CCFL 31 is partially accommodated in the accommodating area 38. As mentioned above, the accommodating area 38 can be respectively disposed on the first substrate 33 and the second substrate 34 of the cold cathode fluorescent lamp module 30, or be disposed on one of the substrates 33 and 34. Herein, at least one part of the CCFL 31 is accommodated in the accommodating area 38 and contacts with the first electrode 321 and the second electrode 322 tightly.

In the present embodiment, the first electrode 321 and the second electrode 322 of the electrode pair 32 are disposed on the first substrate 33 and the second substrate 34, respectively, by way of embedding, coating, printing, or depositing. In addition, the electrode pair 32 is made of a material selected from the group consisting of an electric conductive metal, an electric conductive alloy, and an electric conductive metal-oxide. Herein, the electric conductive metal is at least one selected from the group consisting of copper, silver, aluminum, and nickel. The electric conductive metal-oxide is at least one selected from the group consisting of indium tin oxide, indium zinc oxide, aluminum zinc oxide, and cadmium tin oxide.

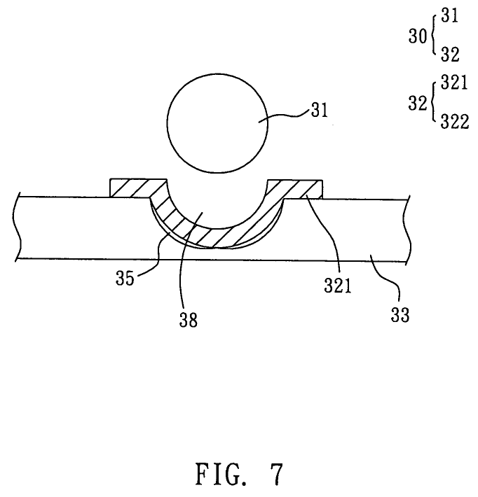

Additionally, with reference to FIG. 7, the first electrode 321 and the second electrode 322 of the electrode pair 32 are constructed on the first substrate 33 or the second substrate 34 by way of embedding, and the accommodating area 38 further includes an electrode deformation buffering area 35. The accommodating area 38 is concaved from the surface of the first substrate 33 or the second substrate 34, and the electrode deformation buffering area 35 is dispoed in the concavity. In this case, the curvature of the electrode deformation buffering area 35 is different from that of the first electrode 321 or the second electrode 322. In such a manner, when the CCFL 31 is installed in the accommodating area 38 and the out surface of the CCFL 31 is unable to contact with the first electrode 321 or the second electrode 322, the electrode deformation buffering area 35 can provide a buffer space for deforming the first electrode 321 and the second electrode 322. Accordingly, the CCFL 31 may contact with the first electrode 321 and the second electrode 322 tightly.

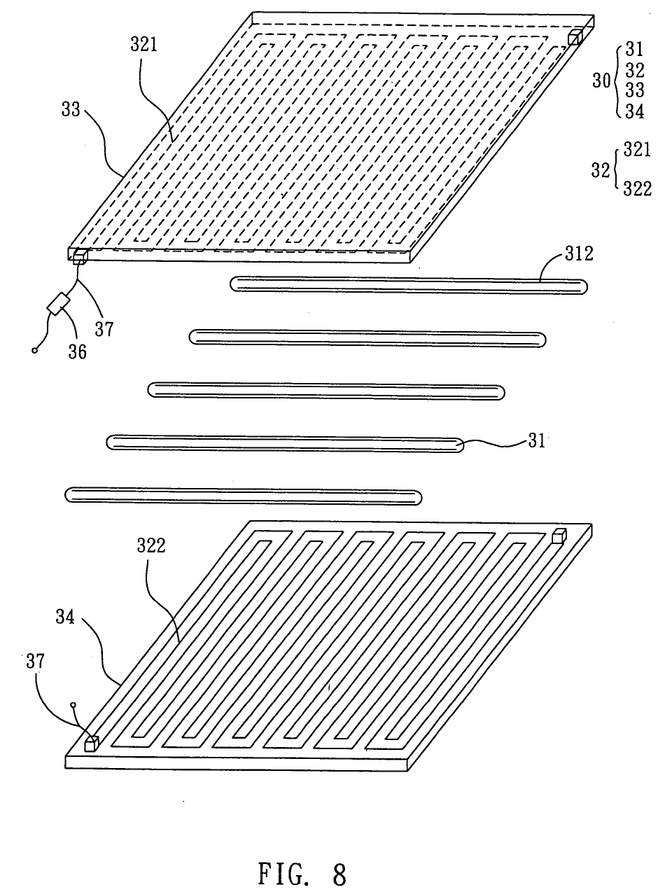

As mentioned above, with reference to FIG. 8, the cold cathode fluorescent lamp module 30 can include a plurality of CCFLs 31. Herein, the electrode pair 32 connects to a power supply 36 through a lead 37. The power supply 36 supplies a high voltage power to generate a high electric field inside the CCFL 31. Then, the gas medium in the CCFL 31 is excited and generates ultraviolet rays. The ultraviolet rays excite the fluorescent material layer 312 on the inner surface of the CCFL 31 to emit visible light eventually. In the present embodiment, the CCFLs 31 can be all driven by a single power supply 36 or be respectively driven by a plurality of power supplies 36.

In the present embodiment, the cold cathode fluorescent lamp module 30 can be used as a backlight module of a display device or as a light source.

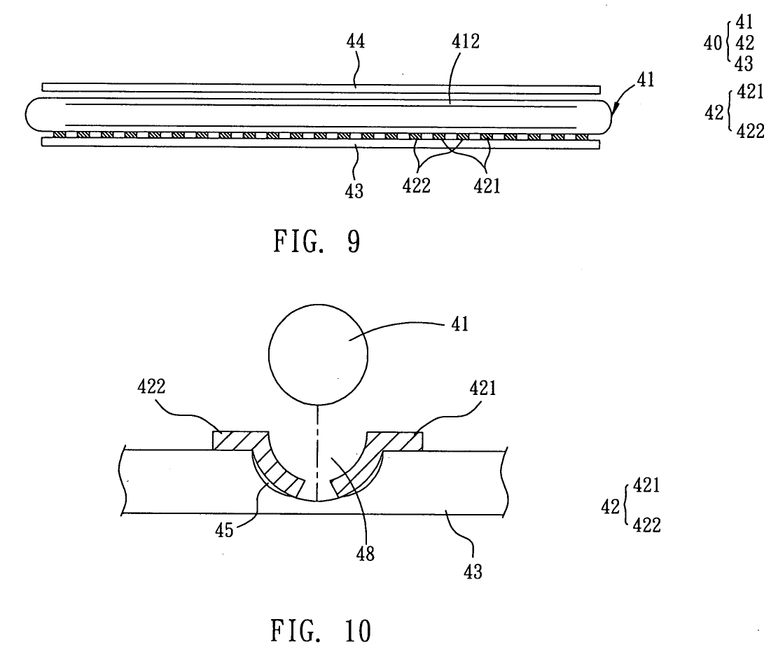

Moreover, with reference to FIG. 9, a cold cathode fluorescent lamp module 40 according to another preferred embodiment of the invention includes a substrate 43, at least one electrode pair 42, and at least one cold cathode fluorescent lamp (CCFL) 41.

As mentioned above, the substrate 43 can be a diffusion substrate or a reflective substrate. Herein, the structure of the CCFL 41 as well as the material and the disposing construction of the electrode pair 42 are the same as those of the previously mentioned CCFL 31 and electrode pair 32, so the detailed descriptions are omitted for concise purpose.

The electrode pair 42 includes a first electrode 421 and a second electrode 422 that are both disposed on the substrate 43 and connected to the CCFL 41. In this case, the first electrode 421 and the second electrode 422 are staggered to each other on the substrate 43.

The substrate 43 can further includes at least one accommodating area 48. As mentioned above, the accommodating area 48 can be concaved (as shown in FIG 10) or protrude form the surface of the substrate 43. The electrode pair 42 is disposed in the accommodating area 48. In such a manner, at least one part of the CCFL 41 is accommodated in the accommodating area 48 and contacts with the first electrode 421 and the second electrode 422 tightly. Due to the structure characters and sectional shape of the accommodating area 48 are the same as those of the previously mentioned accommodating area 38, so the detailed descriptions are omitted for concise purpose.

Moreover, in the present embodiment, the cold cathode fluorescent lamp module 40 further includes a cover 44 opposite to the substrate 43. The cover 44 can be a diffusion substrate or a reflective substrate.

The accommodating area 48 in the present embodiment also further includes an electrode deformation buffering area 45 disposed between the electrode pair 42 and the substrate 43 (as shown in FIG. 10). In addition, how to put the electrode deformation buffering area 45 in practice is the same as those previously mentioned descriptions. The electrode deformation buffering area 45 provides a space for buffering deformation of the CCFL 41 when it connects with the electrode pair 42. In addition, the electrode pair 42 is disposed on the substrate 43 by way of embedding, coating, printing, or depositing.

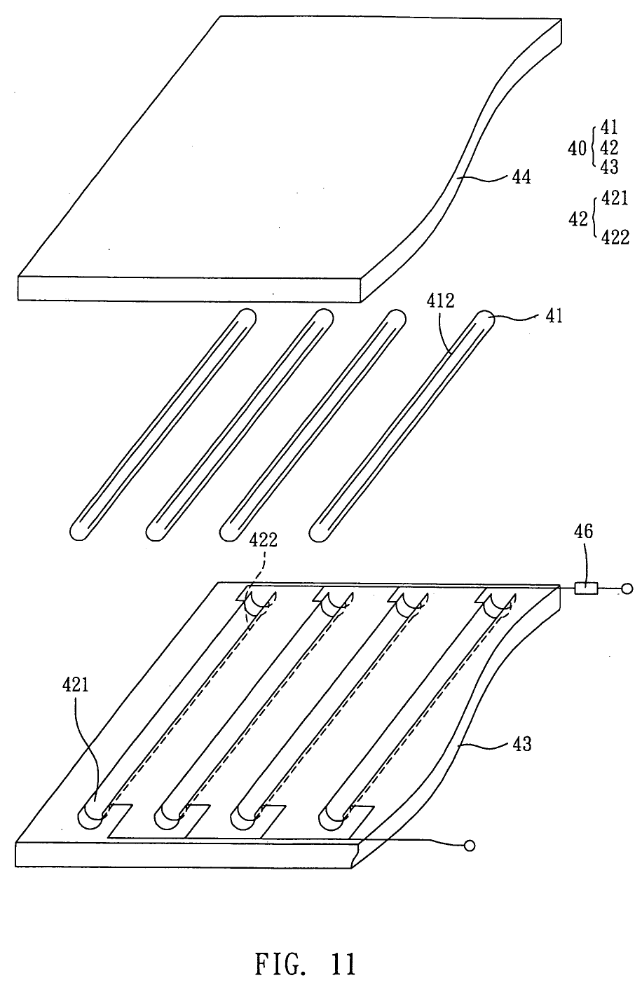

With reference to FIG. 11, the cold cathode fluorescent lamp module 40 includes a plurality of the CCFLs 41. As mentioned above, the electrode pair 42 connects to a power supply 46. The power supply 46 drives the electrode pair 42 to generate a high electric field inside the CCFL 41. After exciting the fluorescent material layer 412 of the CCFL 41, a visible light is generated eventually. As mentioned above, it is a possible way of using a single power supply 46 or a plurality of the power supplies 46 to drive the CCFLs 41.

The cold cathode fluorescent lamp module 40 in the present embodiment can be used as a backlight module of a display device or as a light source.

In conclusion, the invention is to dispose the electrode pair of the cold cathode fluorescent module on a substrate or two substrates. Herein, the electrode pair includes a first electrode and a second electrode. The first electrode and the second electrode can be staggered to each other on the same substrate. In addition, the first electrode and the second electrode also can be respectively disposed on two substrates i.e. the first substrate and the second substrate. In such a manner, the first electrode and the second electrode can be aligned to each other with symmetry or interlaced. Therefore, this invention is to dispose the electrode pair on the substrate so as to form a cold cathode fluorescent lamp module with an external electrode structure. Accordingly, the sealing procedure in the production of the internal metal electrode structure is eliminated and thus the yield, reliability, and lifetime of the product are further improved. Meanwhile, due to the electrode pair is disposed on the substrate, the following assembly of the cold cathode fluorescent lamp to fabricate the cold cathode fluorescent lamp module is simplified. Thus, the requirements of the rapid assembly and mass-production are obtained.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A cold cathode fluorescent lamp module, comprising:
a first substrate;
a second substrate disposed opposite to the first substrate;
an electrode pair having a first electrode and a second electrode disposed on the first substrate and the second substrate, respectively; and
a cold cathode fluorescent lamp disposed between the first substrate and the second substrate.

2. The cold cathode fluorescent lamp module of claim 1, wherein the first electrode and the second electrode are arranged in a symmetric or staggered manner.

3. The cold cathode fluorescent lamp module of claim 1, wherein the first substrate and the second substrate are respectively a diffusion substrate or a reflective substrate.

4. The cold cathode fluorescent lamp module of claim 1, wherein the first electrode and the second electrode are disposed on the first substrate and the second substrate, respectively, by way of embedding, coating, printing, or depositing.

5. The cold cathode fluorescent lamp module of claim 1, wherein the electrode pair is made of copper, silver, aluminum, nickel, an electric conductive metal, an electric conductive alloy, indium tin oxide, indium zinc oxide, aluminum zinc oxide, cadmium tin oxide, or an electric conductive metal-oxide.

6. The cold cathode fluorescent lamp module of claim 1, wherein the first substrate or the second substrate further comprises:
at least one accommodating area disposed on the first substrate or the second substrate for receiving the cold cathode fluorescent lamp, wherein the electrode pair is disposed in the accommodating area and positioned between the cold cathode fluorescent lamp and the first substrate or the second substrate.

7. The cold cathode fluorescent lamp module of claim 6, wherein the accommodating area further comprises an electrode deformation buffering area for allowing the cold cathode fluorescent lamp to contact with the first electrode or the second electrode tightly.

8. The cold cathode fluorescent lamp module of claim 6, wherein the accommodating area is concaved from the surface of the first substrate or the second substrate, and the sectional shape of the accommodating area is semicircle-shaped, arc-shaped, V-shaped, or parabolic curve-shaped.

9. The cold cathode fluorescent lamp module of claim 6, wherein the accommodating area protrudes from the surface of the first substrate or the second substrate and comprises at least two blockers for fixing the cold cathode fluorescent lamp.

10. A cold cathode fluorescent lamp module, comprising:
a substrate;
an electrode pair having a first electrode and a second electrode alternately disposed on the substrate; and
a cold cathode fluorescent lamp disposed on the substrate.

11. The cold cathode fluorescent lamp module of claim 10, wherein the substrate is a diffusion substrate or a reflective substrate.

12. The cold cathode fluorescent lamp module of claim 10, wherein the first electrode and the second electrode are disposed on the substrate by way of embedding, coating, printing, or depositing.

13. The cold cathode fluorescent lamp module of claim 10, the electrode pair is made of an electric conductive metal, an electric conductive alloy, or an electric conductive metal-oxide.

14. The cold cathode fluorescent lamp module of claim 13, wherein the electric conductive metal is copper, silver, aluminum, or nickel, and the electric conductive metal-oxide is indium tin oxide, indium zinc oxide, aluminum zinc oxide, or cadmium tin oxide.

15. The cold cathode fluorescent lamp module of claim 10, wherein the substrate further comprises:
at least one accommodating area disposed on the substrate for receiving the cold cathode fluorescent lamp, wherein the electrode pair is disposed in the accommodating area and positioned between the cold cathode fluorescent lamp and the substrate.

16. The cold cathode fluorescent lamp module of claim 10, wherein the accommodating area further comprises an electrode deformation buffering area for allowing the cold cathode fluorescent lamp to contact with the first electrode or the second electrode tightly.

17. The cold cathode fluorescent lamp module of claim 15, wherein the accommodating area is concaved from the surface of the substrate, and the sectional shape of the accommodating area is semicircle-shaped, arc-shaped, V-shaped, or parabolic curve-shaped.

18. The cold cathode fluorescent lamp module of claim 15, wherein the accommodating area protrudes from the surface of the substrate and comprises at least two blockers for fixing the cold cathode fluorescent lamp.

19. The cold cathode fluorescent lamp module of claim 10, further comprising a cover disposed opposite to the substrate.
